(19) United States
(12) Patent Application Publication
(10) Pub. No.: US 2026/0292490 A1
(43) Pub. Date: Sep. 24, 2026

(54) VEHICLE INFORMATION MANAGEMENT DEVICE

(71) Applicant: HONDA MOTOR CO., LTD., Tokyo (JP)

(72) Inventors: Yusuke MANO, Tokyo (JP); Kei HIROHATA, Tokyo (JP); Haruka KUBO, Tokyo (JP)

(21) Appl. No.: 19/568,823

(22) Filed: Mar. 17, 2026

(30) Foreign Application Priority Data
Mar. 21, 2025 (JP) 2025-046758

(51) Int. Cl. H04W 12/06; B60K 35/85; H04W 60/00

(52) U.S. Cl. CPC H04W 12/06; B60K 35/85; H04W 60/00

(57) ABSTRACT

A vehicle information management device comprises: a user information management unit for registering vehicle owner information; a reception unit for receiving an authentication registration request; a transmission unit for transmitting a first authentication code to a vehicle information device upon receiving the request; and a control unit for: receiving first authentication code confirmation information generated by a mobile device reading the first authentication code; if confirming contents contained in the first authentication code and in the first authentication code confirmation information match, transmitting a second authentication code to the vehicle information device within a predetermined time period from the confirmation; receiving a second authentication code confirmation information generated by the mobile device reading the second authentication code; and if confirming contents contained in the second authentication code and in the second authentication code confirmation information match, registering the owner of the mobile device as an owner of the vehicle.

### CROSS REFERENCE TO THE RELATED APPLICATION

This application is based on and claims the benefit of priority from Japanese Patent Application No. 2025-046758, filed on 21 March 2025, the content of which is incorporated herein by reference.

### BACKGROUND OF THE INVENTION

### Field of the Invention

The present invention relates to a vehicle information management device that enables a user (new owner) who has acquired a vehicle secondhand to register, in order to enjoy telematics services, his/her own user information with simple operations.

### Related Art

Telematics services are expanding for vehicle owners, such as remotely starting the vehicle's engine from a smartphone or other mobile device owned by the user, or displaying the vehicle's parking location on the user's mobile device. To utilize telematics services, users must first register their vehicle and user identification information with a telematics server or the like for authentication.

The authentication registration process for such vehicle and user identification information was conventionally performed at vehicle dealerships. However, to reduce the burden on dealerships as well as users, a system has been developed that allows users to perform the authentication registration process with simple operations using their own mobile devices.

For example, Patent Document 1 discloses an authentication registration system comprising an in-vehicle controller mounted in a vehicle, a user's mobile device, and a registration server that authenticates and registers the vehicle's identification information and the user's mobile device's identification information, wherein the registration server transmits an authentication code signal containing, as data, an authentication code to the vehicle; the vehicle extracts the authentication code from the received authentication code signal and displays it on the Display Audio (DA) device; the user inputs the authentication code displayed on the DA device into his/her mobile device; the mobile device transmits an authentication code confirmation signal containing, as data, the inputted authentication code transmitted to the registration server; the registration server determines that the identification information authentication has succeeded when the authentication code in the authentication code confirmation signal transmitted from the user's mobile device matches the authentication code in the authentication code signal.

Furthermore, Patent Document 2 discloses a digital key system for vehicle comprising a device for vehicle mounted on a vehicle; a mobile device; and a server that generates a service key unique to each mobile device and transmits it to the mobile device, wherein, based on an input of a specific owner registration start signal from a predetermined dedicated device or server, the digital key system for vehicle initiates an owner registration capable mode of registering a service key (owner key) that grants authority as the vehicle owner.

Patent Document 1: Japanese Patent No. 6913141

Patent Document 2: Japanese Patent No. 7550124

### SUMMARY OF THE INVENTION

The technology described in Patent Document 1 is intended solely for the event of initially registering a new vehicle. However, naturally, users who acquire vehicles secondhand also have a need for telematics services. When a user who has acquired a used vehicle (a new owner) wishes to use the service, it is necessary to perform an authentication registration process for the owner information linked to the vehicle, including the new owner's user identification information.

However, the sale of used vehicles does not necessarily occur through authorized dealerships; it may also be conducted through used car dealerships or through private sales or similar arrangements. However, when a sale of a used vehicle did not occur through an authorized dealership, it becomes difficult to verify whether a user attempting to authentication register is a rightful owner (new owner) of the vehicle. To prevent registration by individuals who are not the rightful owners, users are forced to undergo cumbersome procedures (such as requiring them to bring vehicles purchased through private sales to authorized dealerships specifically for authentication registration).

Furthermore, the technology described in Patent Document 2 required inputting a specific owner registration start signal from a designated dedicated device or server to initiate processing for registering an owner key with owner privileges on a mobile device owned by the vehicle owner. This inevitably led to increased system complexity and/or cumbersome processing.

Accordingly, a new arrangement has been needed that would allow user information to be authentication registered upon confirming easily and conveniently the new owner is a rightful owner without having to bring the vehicle acquired secondhand to an authorized dealership.

The present invention aims to provide a vehicle information management device that enables a user (new owner) who has purchased a vehicle secondhand to register, upon being confirmed that the new owner is a rightful owner, user information for enjoying telematics services based on simple operations performed by the new owner.
1. A vehicle information management device of the present invention (for example, “management server 2” described later) comprising: a user information management unit (for example, “vehicle/user information management unit 211” described later) configured to register owner information pertaining to a vehicle (for example, “vehicle 6” described later) including user identification information and contact details for a user; a reception unit (for example, “reception unit 232” described later) configured to receive an authentication registration request from either a first mobile device (for example, “mobile device 3-1” described later) held by a first user who becomes a new owner of the vehicle or a vehicle information device mounted in the vehicle (for example, “in-vehicle controller 4” and “IVI device 5” described later); a transmission unit (for example, “transmission unit 231” described later) configured to transmit, to the vehicle information device, first authentication code information to be displayed on the vehicle information device when the authentication registration request is received; a control unit (for example, “control unit 212” described later)configured to: receive, by the reception unit, first authentication code confirmation information, which is information generated by the first mobile device reading the first authentication code information displayed on the vehicle information device; transmit from the transmission unit, if it is confirmed that contents of authentication registration information contained respectively in the first authentication code information and in the first authentication code confirmation information match, second authentication code information to be displayed on the vehicle information device within a first predetermined time period from the confirmation; receive, by the reception unit, second authentication code confirmation information, which is information generated by the first mobile device reading the second authentication code information; instructs the user information management unit to register the identification information of the first user as an owner information for the vehicle, if it is confirmed that the contents of authentication registration information contained respectively in the second authentication code information and the second authentication code confirmation information match.
2. In the vehicle information management device according to (1), the reception unit may further receive “on” information indicating that the vehicle is in a started state and “off” information indicating that the vehicle is in a non-started state, and the control unit, after confirming that contents of authentication registration information contained respectively in the first authentication code information and the first authentication code confirmation information match, may receive the “off” information, subsequently, after receiving the “on” information, and if it confirms that contents of authentication registration information contained respectively in the second authentication code information and the second authentication code confirmation information match, and may instruct the user information management unit to register the identification information of the first user as an owner information for the vehicle.
3. In the vehicle information management device according to (1), the control unit, after confirming that contents of authentication registration information contained respectively in the first authentication code information and the first authentication code confirmation information match, may transmit the second authentication code information to the vehicle information device after a second predetermined time shorter than the first predetermined time has elapsed, and if it confirms that the contents of authentication registration information contained respectively in the second authentication code information and the second authentication code confirmation information match, may instruct the user information management unit to register the identification information of the first user as an owner information for the vehicle.
4. In the vehicle information management device according to (1), the control unit, after transmitting the second authentication code information to be displayed on the vehicle information device from the transmission unit to the vehicle information device, if it receives the second authentication code confirmation information from a second mobile device held by a second user who is the former owner of the vehicle, it may instruct the user information management unit not to register the identification information of the first user as an owner information for the vehicle.

The vehicle information management device of the present invention enables performing an authentication registration process for user information after easily and conveniently confirming that a new owner is a rightful owner without bringing a vehicle to an authorized dealership. Additionally, the vehicle information management device of the present invention enables verifying that a new owner is a rightful owner in a simple yet accurate manner. The vehicle information management device of the present invention enables the protection of the new owner's privacy. Furthermore, the vehicle information management device of the present invention enables preventing fraudulent vehicle registration.

### BRIEF DESCRIPTION OF THE DRAWINGS

FIG. 1 is a diagram illustrating the configuration of an authentication registration system including a vehicle information management device (management server) according to an embodiment of the present invention.

FIG. 2 is a block diagram illustrating the configuration of a vehicle information management device (management server) according to an embodiment of the present invention.

FIG. 3 is a block diagram illustrating the configuration of a mobile device, which is an element of the authentication registration system according to an embodiment of the present invention.

FIG. 4 is a block diagram illustrating the configuration of an in-vehicle controller, which is an element of the authentication registration system according to an embodiment of the present invention.

FIG. 5 is a diagram illustrating an example of communication operations for authentication registration processing within the authentication registration system.

FIG. 6 is a diagram illustrating an example of communication operations for authentication registration processing within the authentication registration system (continuation of FIG. 5).

FIG. 7 is a diagram illustrating another example of communication operations for authentication registration processing within the authentication registration system.

FIG. 8 is a diagram illustrating another example of communication operations for authentication registration processing within the authentication registration system (continuation of FIG. 7).

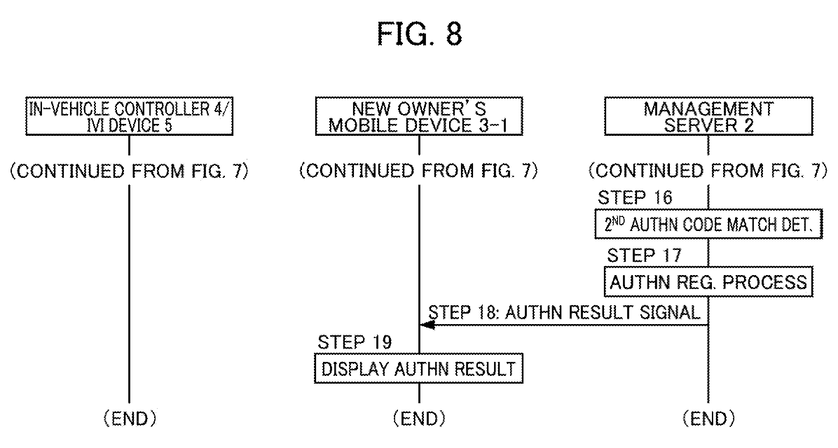

FIG. 9 is a diagram illustrating communication operations for cancellation process of authentication registration within the authentication registration system.

FIG. 10 is a flowchart illustrating the authentication registration process flow in the vehicle information management device (management server) according to an embodiment of the present invention.

### DETAILED DESCRIPTION OF THE INVENTION

The following describes a vehicle information management device (management server) according to an embodiment of the present invention, with reference to the drawings. The vehicle information management device (management server) of this embodiment is intended for users to register identification information related to their owned vehicles themselves, for purposes such as using telematics services.

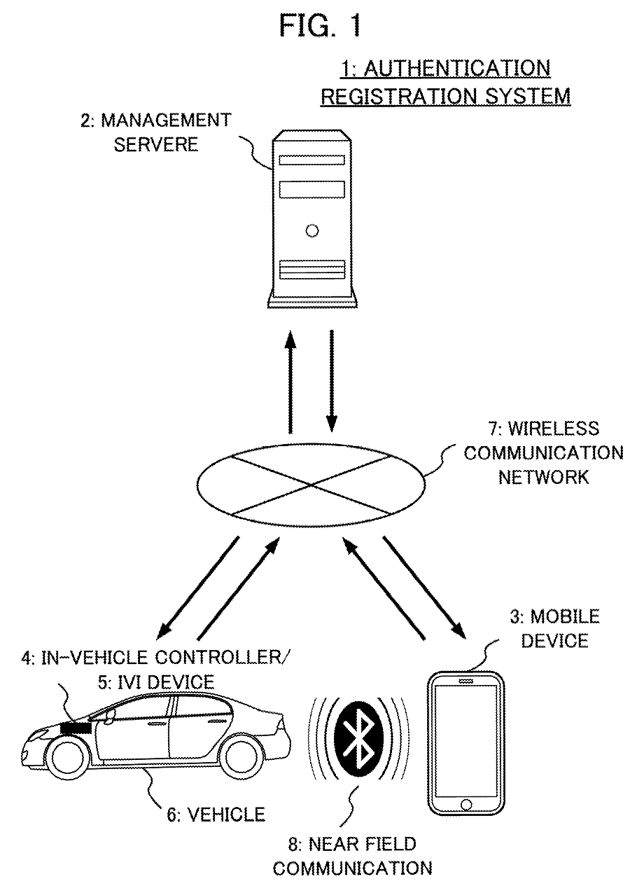

As shown in FIG. 1, the authentication registration system 1 according to this embodiment comprises at least a management server 2, a plurality of mobile devices 3 (only one shown), and an in-vehicle controller 4 and an IVI device 5 (both only one shown) mounted in a plurality of vehicles 6. These components 2 to 5 can be connected to each other for data communication via a wireless communication network 7. Additionally, the mobile device 3 and the in-vehicle controller 4 can be paired via near field communication 8.

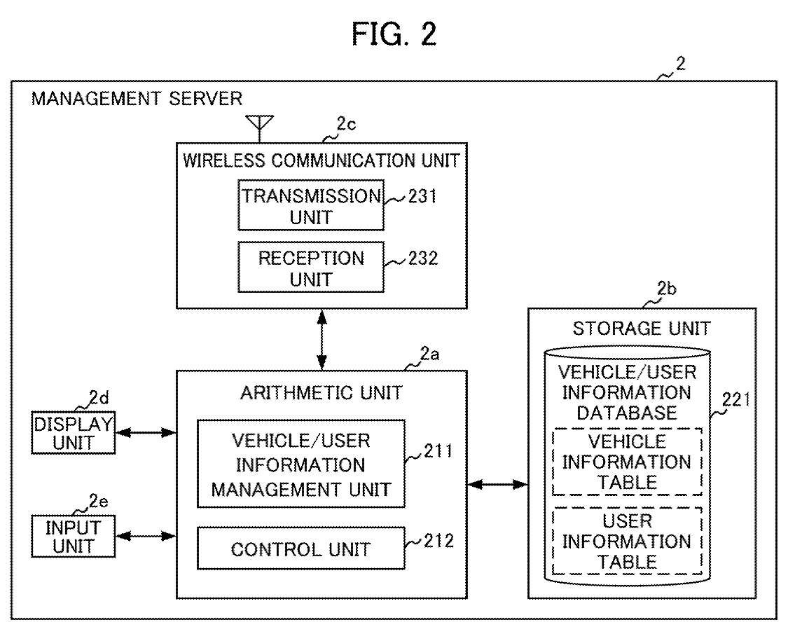

As shown in FIG. 2, the management server 2 comprises an arithmetic unit 2a, a storage unit 2b, a wireless communication unit 2c, a display unit 2d, an input unit 2e, and other components. The arithmetic unit 2a includes a vehicle/user information management unit 211, a control unit 212, and other components. Additionally, the storage unit 2b includes a vehicle/user information database 221, and other components. Here, the vehicle/user information database 221 is preferably a so-called relational database, wherein the vehicle information table and the user information table are mutually associated. If the vehicle/user information database 221 is a relational database, it becomes easy to search for user information (e.g., the owner's contact details) associated with a specific vehicle based on vehicle identification information, or to search for vehicle information associated with a specific vehicle owned by a user based on user identification information.

Additionally, the wireless communication circuit 2c includes a transmission unit 231 and a reception unit 232. It can transmit data from the transmission unit 231 to the in-vehicle controller 4 or the mobile device 3 via the wireless communication network 7 and can receive data from the in-vehicle controller 4 or the mobile device 3 via the wireless communication network 7 using the reception unit 232. Note that the management server 2 of this embodiment corresponds to the vehicle information management device of the claims.

The management server 2 can perform data communication with the mobile device 3 and the in-vehicle controller 4 via the wireless communication unit 2c and the wireless communication network 7. Then, through this data communication, authentication registration process described later is performed, and when this authentication registration succeeds, various identification information is registered (stored) in the vehicle/user information database 221 within the storage unit 2b.

Once various identification information is registered in the storage unit 2b of the management server 2, users can subsequently utilize telematics services. For example, users can operate their own mobile device 3 to perform remote operations such as starting an engine of a registered vehicle, or displaying the vehicle's parking location on the mobile device 3.

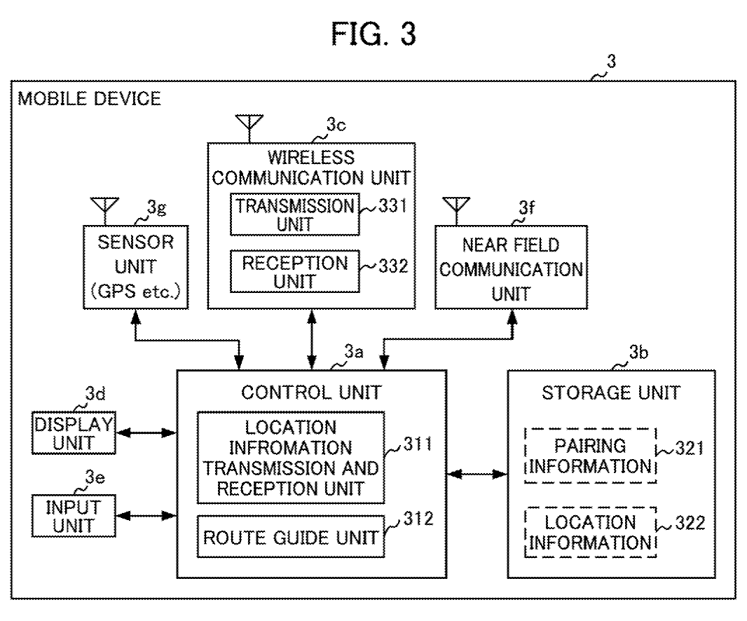

The mobile device 3 is a smartphone, a tablet, or similar devices owned by a user. As shown in FIG. 3, it includes a control unit 3a, a storage unit 3b, a wireless communication unit 3c, a display unit 3d, an input unit 3e, a near field communication unit 3f, and a sensor unit (such as GPS) 3g. The mobile device 3 is capable of connecting to the wireless communication network 7 via the wireless communication unit 3c. The wireless communication unit 3c includes a transmission unit 331 and a reception unit 332, enabling data communication with the management server 2 and the vehicle controller 4 connected via the wireless communication network 7. Then, authentication registration process described later is executed via the data communication.

The control unit 3a comprises a microcomputer equipped with a processor, memory, I/O interface, etc., and includes a location information reception unit 311, a route guide unit 312, and other components. The storage unit 3b is a storage for the control unit 3a (microcomputer), storing basic software (not shown) for operating the microcomputer, as well as pairing information 321 between the mobile device 3 and the vehicle controller 4, position information 322 acquired from the sensor unit (GPS) 3g, and other data. Pairing between the mobile device 3 and the in-vehicle controller 4 will be described later.

Additionally, the storage unit 3b of the mobile device 3 has application software for predetermined communication services (hereinafter referred to as "communication app") installed by a user. By executing the communication app, it becomes possible to perform data communication with the management server 2, as described later. This enables performing such as transmitting an authentication registration request signal described later to the management server 2 based on a user's input operation to the display unit 3d.

Additionally, a transparent touch panel is laminated onto the display unit 3d. When a user performs a specific input action (e.g., tap, swipe, pinch out, pinch in) on the touch panel, an operation signal representing that action is output to the control unit 3a. The display unit 3d with the touch panel can also function as the input unit 3e.

Furthermore, the near field communication unit 3f complies with near field communication standards such as “Bluetooth (registered trademark)”. This enables pairing between the mobile device 3 and the in-vehicle controller 4 mounted in the vehicle 6 when the user boards the vehicle 6 while carrying the mobile device 3 and allowing near field communication between them.

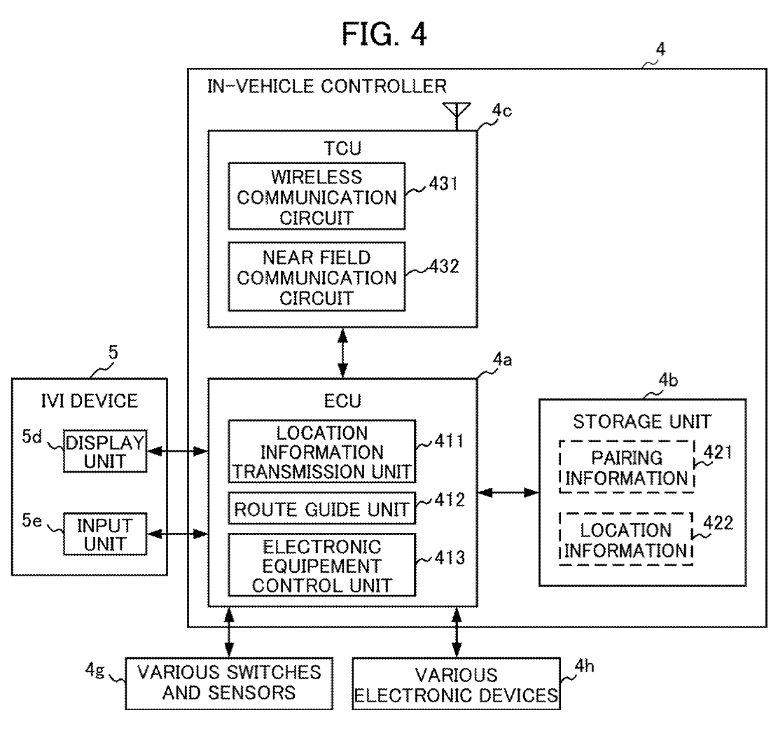

The in-vehicle controller 4 is mounted in the vehicle 6 and, as shown in FIG. 4, comprises an ECU (Electronic Control Unit) 4a, a storage unit 4b, and a TCU (Telematics Control Unit) 4c. Additionally, the in-vehicle controller 4 is connected to various external switches and sensors 4g, as well as various electronic devices 4h. Various switches and sensors include, for example, an ignition switch, a wiper switch, a light switch, a GPS sensor, a temperature sensor, a seat belt sensor, a seat (occupancy) sensor, and so on.

Both the ECU 4a and the TCU 4c are microcomputers composed of processors, storages, memories, I/O interfaces and so on. The ECU 4a includes a position information transmission unit 411, a route guide unit 412, an electronic device control unit 413, and so on. The TCU 4c includes a wireless communication circuit 431 and a near field communication circuit 432, which will be described later.

The ECU 4a is a device that controls various onboard electronic equipment. The electronic device control unit 413, based on signal inputs from various external switches and sensors (collectively labeled as various switches and sensors 4g in FIG. 4), controls, for example, an ignition, an engine (including throttles and fuel injectors), a battery, a motor, a clutch, transmission gears, differential gears, and other power/drive system components; a steering, brakes, suspensions, and other running stability/handling system components; and wipers, lights, airbags, interior/exterior monitors, an air conditioner, and other safety/environmental system components. This enables a wide range of functions, such as throttle-by-wire/traction controls, automatic idling stop controls, hybrid controls of an engine/motor, lane keeping/cruise controls/autonomous driving, anti-skid braking controls, differential gears’ slip controls, active suspension/ active height controls, various warnings for a driver, and cabin environment controls.

In contrast, the TCU 4c is a communication unit that enables bidirectional information exchange between the vehicle 6 and the outside of the vehicle 6 in response to requests, for example, from the ECU 4a. It is a key device for realizing so-called connected cars, that is, vehicles equipped with IoT (Internet of Things) device capabilities. The aforementioned telematics services (such as remotely starting an engine of the vehicle 6 from the mobile device 3, displaying a parking location of the vehicle 6 on the mobile device 3, etc.) are also realized by the ECU 4a receiving commands from the mobile device 3 via the TCU 4c and controlling various electronic devices.

The TCU 4c comprises a wireless communication circuit 431 and a near field communication circuit 432. The wireless communication circuit 431 incorporates a SIM card (not shown). This SIM card stores various information based on the contract with the telecommunications carrier, enabling the in-vehicle controller 4 to perform data communication with the vehicle information management device (management server 2) of the present invention and the mobile device 3 from the wireless communication circuit 431 of the TCU 4c via the wireless communication network 7. Then, an authentication registration process described later is performed via the data communication.

Furthermore, the near field communication circuit 432 complies with near field communication standards such as “Bluetooth (registered trademark)”. This enables the vehicle controller 4 and the mobile device 3 to pair when the user boards the vehicle 6 while carrying the mobile device 3, allowing near field communication between them.

Besides a control program of the ECU 4a (not shown), vehicle identification information and user identification information (both not shown) are also stored within the storage unit 4b. This vehicle identification information is identification information and is assigned for the vehicle 6 at the time when the vehicle 6 is manufactured. Additionally, user identification information is identification information for an owner of the vehicle 6. It is assigned, for example, when the vehicle 6 is sold to the owner, and when the vehicle 6 is sold secondhand to another owner, new user identification information is assigned for the new owner. Furthermore, based on commands from the control program within the storage unit 4b and input data from the various switches and sensors 4g, the electronic device control section 413 of the ECU 4a executes the aforementioned various control processes.

Additionally, pairing information 421, location information 422, and other data are also stored within the storage unit 4b. The route guide unit 412 of the ECU 4a periodically acquires position information 422 of the vehicle 6 from a GPS sensor included in the various switches and sensors 4gand stores it in the storage unit 4b. Location information 422 stored in the storage unit 4b is used when the route guide unit 412 provides route guidance (car navigation) to a user via the IVI device 5. Additionally, it is transmitted to the mobile device 3 via the location information transmission unit 411 when displaying, as part of the telematics service, a parking location of the vehicle 6 on the mobile device 3.

The storage unit 4b further stores ignition on/off information (not shown) indicating a time when a user performed ignition on/off and a position of the vehicle 6 at that time. This ignition on/off information is transmitted to the management server 2 at an appropriate time and is used for providing telematics services.

The IVI device 5 is a device that works in conjunction with the in-vehicle controller 4 to provide both informational and entertaining elements. “IVI” is an abbreviation for In-Vehicle Infotainment, and “infotainment” is a portmanteau combining the words “information” and “entertainment”. The provision of informational elements includes, for example, route guidance (car navigation) and displaying of road traffic information. The provision of entertaining elements includes, for example, car audio systems, in-vehicle DVD players, TV tuners, and displaying of internet content.

The IVI device 5 includes a display unit 5d, an input unit 5e, and other components. The display unit 5d is a so-called touch panel, which consists of a transparent touchpad laminated onto a display device such as an LCD panel or an OLED panel. The display unit 5d, which is a touch panel, can also serve as the input unit 5e. Additionally, the display unit 5d can display a barcode (preferably a two-dimensional barcode such as a “QR code (registered trademark)”).

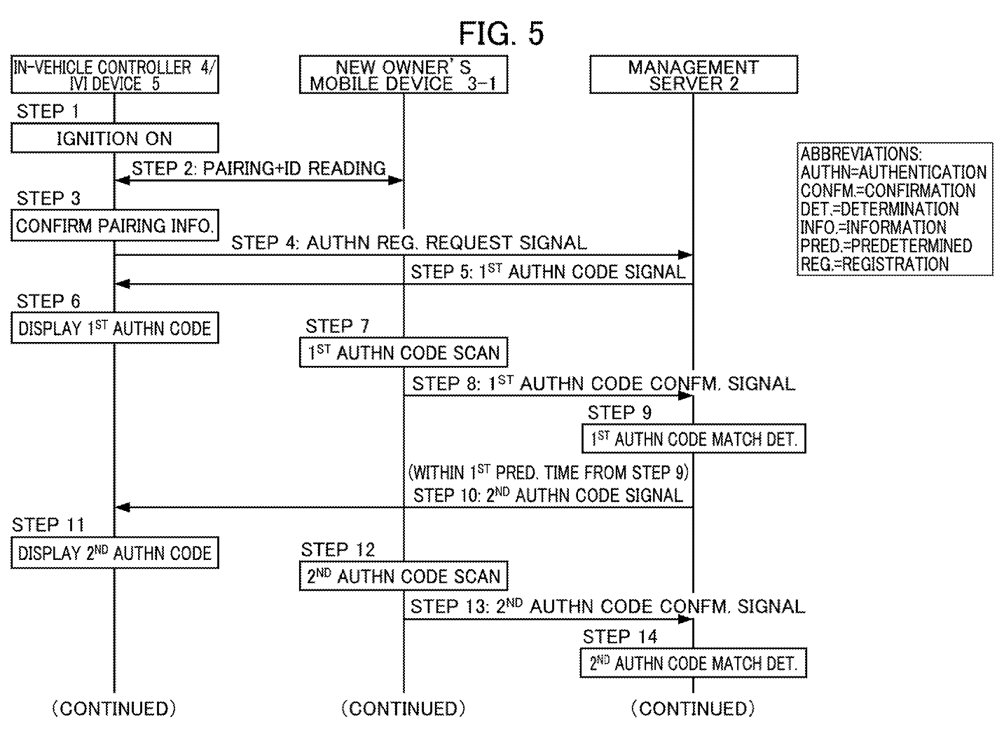

Next, communication operations, which are performed during authentication registration by the authentication registration system 1 of this embodiment, will be explained with reference to FIG. 5. As shown in FIG. 5, when a user (new owner) who acquired the vehicle secondhand boards the vehicle with a mobile device 3-1 having the communication app installed and starts the in-vehicle controller 4 (FIG. 5/STEP 1: the in-vehicle controller 4 is activated upon ignition), the in-vehicle controller 4 automatically establishes a pairing via near field communication with the mobile device 3-1 and reads the device identification information from the mobile device 3-1 (FIG. 5/STEP 2). Subsequently, the vehicle controller 4 searches pairing information 421 within the storage unit 4b to confirm whether pairing information exists or not based on device identification information read from the paired mobile device 3-1 (FIG. 5/STEP 3).

If pairing information based on device identification information read from the mobile device 3-1 does not exist in pairing information 421 stored in the storage unit 4b, the in-vehicle controller 4 determines that the boarding user is a new owner of the vehicle 6 and transmits an authentication registration request to the management server 2 (FIG. 5/STEP 4). Alternatively, the in-vehicle controller 4 may display a message on the display unit 5d prompting a user holding the mobile device 3-1 to perform authentication registration (e.g., “Authentication registration is required to use telematics services. Access the address displayed on the screen to begin authentication registration.”), thereby causing an authentication registration request sent from the mobile device 3-1 to the management server 2. Additionally, the display unit 5d may display a message prompting a user to register for authentication along with a message prompting the user to install the communication app on the mobile device 3-1.

The management server 2 transmits a first authentication code to the in-vehicle controller 4 upon receiving an authentication registration request from either the in-vehicle controller 4 or the mobile device 3-1 (FIG. 5/STEP 5). Here, the first authentication code is a code used by the management server 2 to transmit a second authentication code to the in-vehicle controller 4, provided that the code sent to the in-vehicle controller 4 and the code received from the mobile device 3-1 matches.

When the TCU 4c of the in-vehicle controller 4 receives a first authentication code from the management server 2, the ECU 4a converts the first authentication code into a first barcode (preferably a two-dimensional barcode such as a “QR code (registered trademark)”) and displays it on the display unit 5d of the IVI device 5 (FIG. 5/STEP 6). Additionally, when converting the first authentication code into a first barcode, the ECU 4a lets the first barcode includes address information required to access the management server 2 along with the first authentication code information. Additionally, when displaying the first barcode on the display unit 5d, the ECU 4a also displays a message prompting a user to launch the communication app and scan the first barcode. The screen displaying the first barcode and the message shown on the display unit 5d is hereinafter referred to as the “first setup screen”.

When a user launches the communication app on the mobile device 3-1 and scans the first barcode included in the first setup screen (FIG. 5/STEP 7), the wireless communication unit 3c of the mobile device 3-1 connects to the management server 2 via the wireless communication network 7 for enabling data communication and transmits a first authentication code confirmation signal based on the scanned first barcode from the transmission unit 331 (FIG. 5/STEP 8). Here, the first authentication code confirmation signal includes not only the first authentication code contained within the scanned first barcode, but also user identification information, vehicle identification information, identification information of the mobile device 3, and so on.

The control unit 213 of the processing unit 2a of the management server 2 extracts the first authentication code from the first authentication code confirmation signal received from the mobile device 3-1. Then, the control unit 213 determines whether the first authentication code extracted from the first authentication code confirmation signal received by the management server 2 from the mobile device 3-1 matches the first authentication code sent by the management server 2 to the in-vehicle controller 4 (FIG. 5/STEP 9). Upon determining a match, the control unit 213 transmits a second authentication code to the in-vehicle controller 4 within a first predetermined time period (e.g., 48 hours) (FIG. 5/STEP 10).

When the TCU 4c of the in-vehicle controller 4 receives a second authentication code from the management server 2, the ECU 4a converts the second authentication code into a second barcode (preferably a two-dimensional barcode) and displays it on the display unit 5d of the IVI device 5 (FIG. 5/STEP 11). Additionally, when converting the second authentication code into a second barcode, the ECU 4a lets the second barcode, similar to the first barcode, includes address information required to access the management server 2 along with the second authentication code information. Additionally, when displaying the second barcode on the display unit 5d, the ECU 4a also displays a message prompting a user to launch the communication app and scan the second barcode. The screen displaying the second barcode and the message shown on the display unit 5d is hereinafter referred to as the “second setup screen”.

When a user launches the communication app on the mobile device 3-1 and scans the second barcode included in the second setup screen (FIG. 5/STEP 12), the wireless communication unit 3c of the mobile device 3-1 connects to the management server 2 via the wireless communication network 7 for enabling data communication and transmits a second authentication code confirmation signal based on the scanned barcode from the transmission unit 331 (FIG. 5/STEP 13). Here, the second authentication code confirmation signal includes not only the second authentication code contained within the scanned second barcode, but also user identification information, vehicle identification information, identification information of the mobile device 3, and so on.

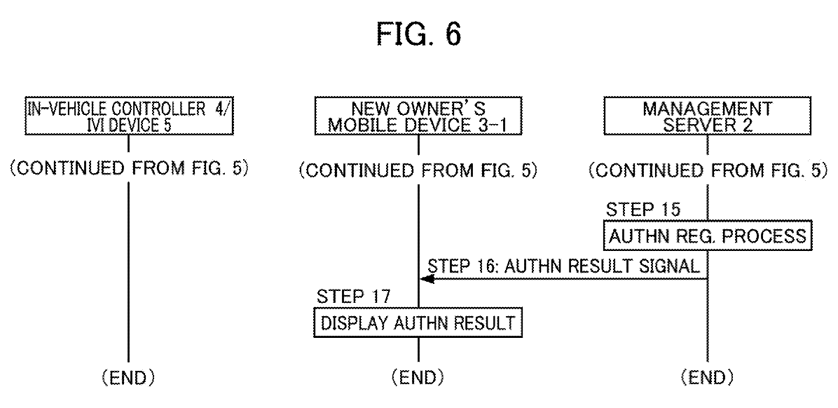

The control unit 213 of the processing unit 2a of the management server 2 extracts the second authentication code from the second authentication code confirmation signal received from the mobile device 3-1. Then, the control unit 213 determines whether the second authentication code extracted from the second authentication code confirmation signal received by the management server 2 from the mobile device 3-1 matches the second authentication code sent by the management server 2 to the in-vehicle controller 4 (FIG. 5/STEP 14). Upon determining a match, the control unit 213 registers vehicle identification information, user identification information, etc., extracted from the second authentication code confirmation signal into the vehicle/user information database 221 and completes the authentication registration (FIG. 6/STEP 15).

That is, receiving a first authentication code confirmation signal and determining a first authentication code match, followed by receiving a second authentication code confirmation signal and determining a second authentication code match within a first predetermined time period (e.g., 48 hours), indicates that a user possessing the mobile device 3-1 has continued managing the vehicle 6 at least from the time the first authentication code confirmation signal was received until the time the second authentication code confirmation signal was received. Therefore, it is highly probable that the user possessing the mobile device 3-1 is a rightful owner of the vehicle 6. Therefore, the management server 2 performs an authentication registration based on a determination that two authentication codes matched at an interval, thereby confirming that a user attempting the authentication registration is a rightful owner (new owner) of the vehicle 6.

After completing the authentication registration, the management server 2 transmits a signal indicating the authentication result to the mobile device 3-1 (FIG. 6/STEP 16). Upon receiving the signal indicating the authentication result, the mobile device 3-1 displays the authentication result on the display unit 3d for notification to the user (new owner) (FIG. 6/STEP 17).

The above describes the basic authentication registration process (hereinafter referred to as the “basic process”) performed in the authentication registration system 1. However, several optional processes are performable, so their details are explained below.

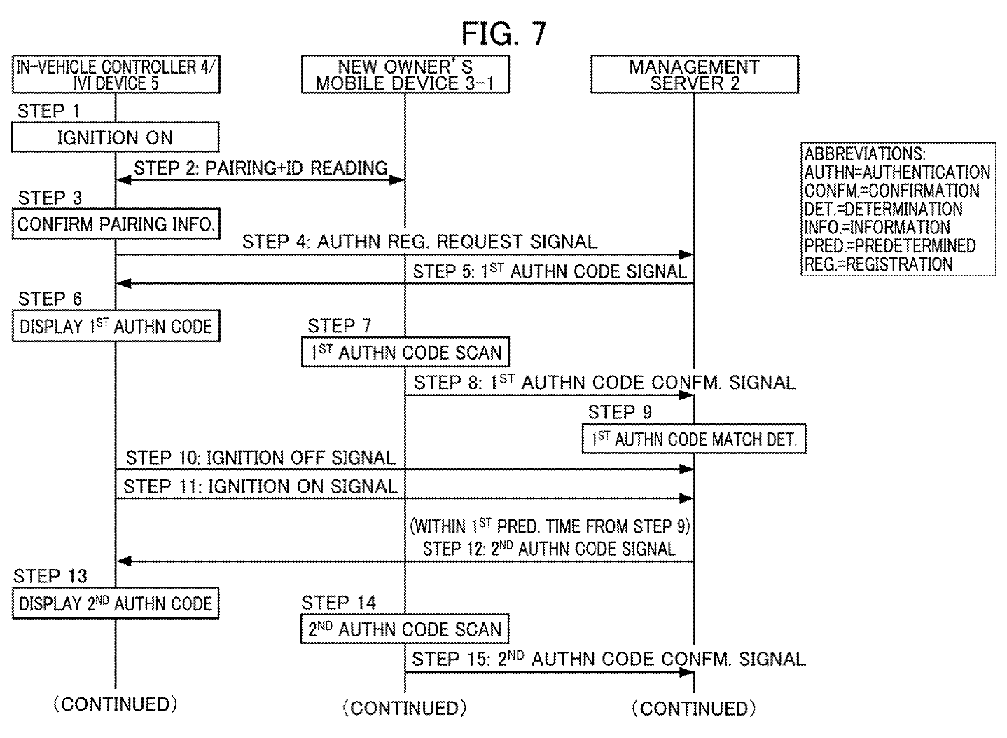

Firstly, in the basic process, the management server 2 transmits, upon determining the match of the first authentication code (FIG. 5/STEP 9), the second authentication code to the in-vehicle controller 4 after the first predetermined time (e.g., 48 hours) has elapsed. However, the management server 2 may instead transmits the second authentication code to the in-vehicle controller 4 (FIG. 7/STEP 12) only when it receives at least one set of ignition-off signals (FIG. 7/STEP 10) and ignition-on signals (FIG. 7/STEP 11) from the in-vehicle controller 4 within the first predetermined time period.

That is, receiving at least one set of ignition-off and ignition-on signals within the first predetermined time period after receiving the first authentication code confirmation signal from the mobile device 3-1 suggests that the user possessing the mobile device 3-1 parked the vehicle 6 and then returned to it. This information strengthens the probability that the user is managing the vehicle 6. Therefore, by adding the reception of at least one set of ignition-off and ignition-on signals to the conditions under which the management server 2 transmits the second authentication code to the in-vehicle controller 4, the reliability of the inference that the user attempting authentication registration is the rightful owner (new owner) of the vehicle 6 can be improved.

Secondly, in the basic process, the management server 2 transmits, upon determining the match of the first authentication code (FIG. 5/STEP 9), the second authentication code to the in-vehicle controller 4 within the first predetermined time period (FIG. 5/STEP 10). However, the management server 2 may transmit, after determining the match of the first authentication code, the second authentication code to the vehicle controller 4 within the first predetermined time (e.g., 48 hours) and after a second predetermined time (e.g., 12 hours) shorter than the first predetermined time has elapsed and perform a second authentication code match determination.

That is, by transmitting the second authentication code to the in-vehicle controller 4 and performing the second authentication code match determination no earlier than after the second predetermined time period (e.g., 12 hours) has elapsed since the first authentication code match determination, it can be inferred that if the second authentication code match is determined, the user possessing the mobile device 3-1 has continued to manage the vehicle 6 for at least the second predetermined time period (e.g., 12 hours). Therefore, by adding at least a second predetermined time interval to the conditions under which the management server 2 transmits the second authentication code to the in-vehicle controller 4 and performs the second authentication code match determination, the reliability of the inference that the user attempting authentication registration is the rightful owner (new owner) of the vehicle 6 can be improved.

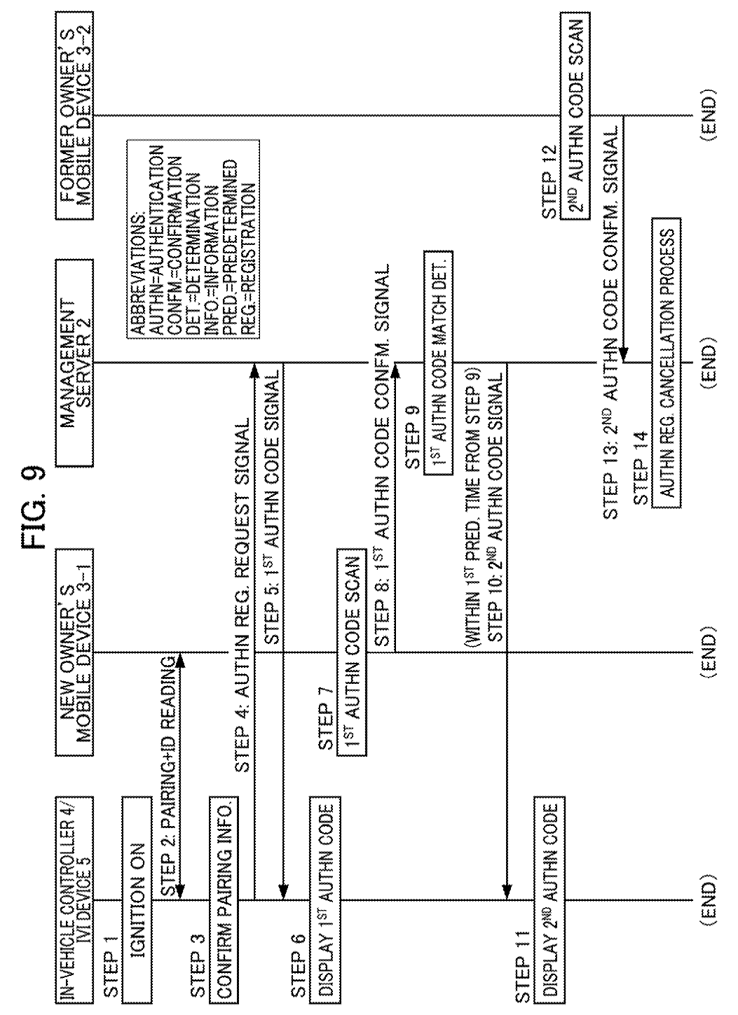

Thirdly, after the control unit 212 of management server 2 transmitted the second authentication code to be displayed on the display unit 5d of the IVI device 5 from the transmission unit 231 to the in-vehicle controller 4 (FIG. 9/STEP 10), if it received the second authentication code confirmation information from the mobile device 3-2 owned by the user registered in the vehicle/user information database 221 as the owner (registered owner) of the vehicle 6 (FIG. 9/STEP 13), the control unit 212 may cancel the authentication registration (FIG. 9/STEP 14) and instruct the vehicle/user information management unit 211 not to register the identification information of the first user as the owner information of the vehicle 6.

That is, receiving the second authentication code confirmation information from the mobile device 3-2 owned by the registered owner (FIG. 9/STEP 13) means that the registered owner, who boarded the vehicle 6 while possessing the mobile device 3-2, scanned the second authentication code (barcode converted) appeared on the display 5d of the IVI device 5 using his/her own mobile device 3-2 and transmitted the second authentication code confirmation signal. This indicates that the registered owner intends to continue enjoying telematics services for the vehicle 6. Therefore, it is highly probable that no change of ownership for the vehicle 6 has occurred (i.e., the user possessing the mobile device 3-1 is not the rightful owner of the vehicle 6). Another possibility is that the registered owner may have boarded the vehicle 6 with the intent to prevent a malicious user from being registered as a new owner. Therefore, the management server 2, upon receiving a second authentication code confirmation signal from the mobile device 3-2, may prevent unauthorized user registration by performing the authentication registration cancellation process.

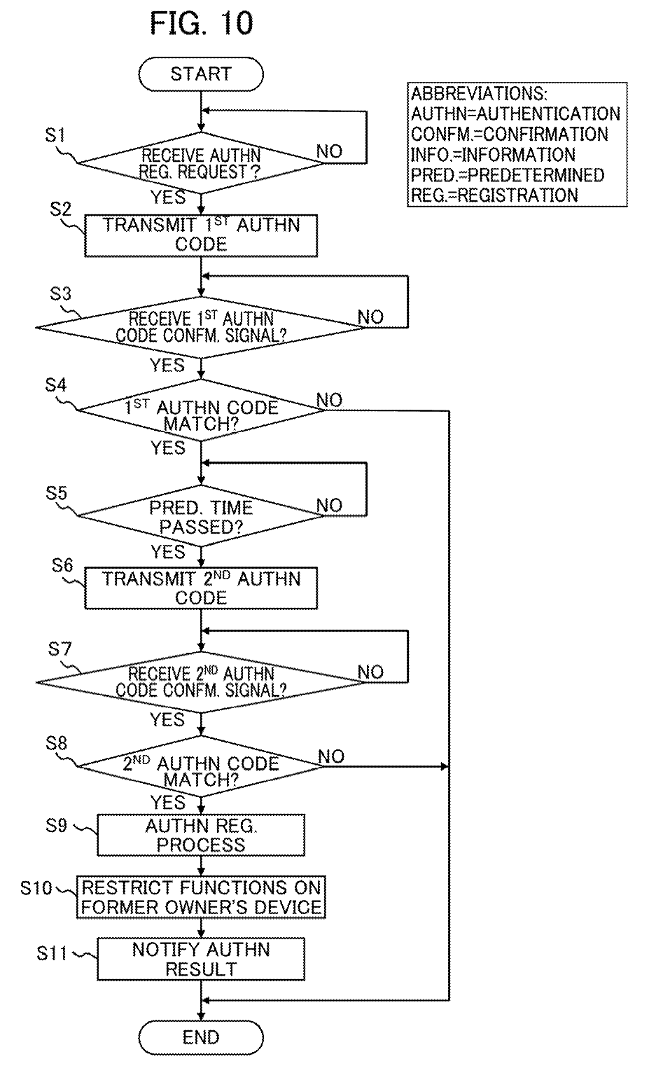

An example of the authentication registration process flow in the management server 2 according to this embodiment is explained using a flowchart in FIG. 10.

When the management server 2 receives an authentication registration request from either the in-vehicle controller 4 or the mobile device 3-1 (YES in FIG. 10/S1), it transmits an authentication code signal to the in-vehicle controller 4 (FIG. 10/S2).

Next, when the management server 2 receives a first authentication code confirmation signal from the mobile device 3-1 (YES in FIG. 10/S3), it determines whether the first authentication code extracted from the first authentication code confirmation signal received by the management server 2 from the mobile device 3-1 matches the first authentication code sent by the management server 2 to the in-vehicle controller 4 (FIG. 10/S4). If the first authentication code matches (YES in FIG. 10/S4), after a predetermined time within the first predetermined time period has elapsed (YES in FIG. 10/S5), the management server 2 transmits a second authentication code signal to the in-vehicle controller 4 (FIG. 10/S6).

Next, when the management server 2 receives the second authentication code confirmation signal from the mobile device 3-1 (YES in FIG. 10/S7), it determines whether the second authentication code extracted from the second authentication code confirmation signal received by the management server 2 from the mobile device 3-1 matches the second authentication code sent by the management server 2 to the in-vehicle controller 4 (FIG. 10/S8). If the second authentication code matches (YES in FIG. 10/S8), the management server 2 registers vehicle identification information, user identification information, etc., into the vehicle/user information database 221 and completes the authentication registration (FIG. 10/STEP 9).

Next, if the previous owner's mobile device 3-2 is registered, the management server 2 restricts the telematics service functions related to the vehicle 6 for the mobile device 3-2 (FIG. 10/S10), notifies the mobile device 3-1 of the authentication result (FIG. 10/S11), and terminates the authentication registration process.

If the first authentication code extracted from the first authentication code confirmation signal received by the management server 2 from the mobile device 3-1 does not match (NO in FIG. 10/S4), and if the second authentication code extracted from the second authentication code confirmation signal received by the management server 2 from the mobile device 3-1 does not match (NO in FIG. 10/S8), the process terminates without performing authentication registration.

### Modifications

The above-described embodiments and several options are all preferred embodiments of the present invention. However, the technical scope of the present invention is not limited to these embodiments alone. Various modifications may be made within the scope of the present invention without departing from its essence.

For example, in the above-described embodiment and its options, the first predetermined time is set to 48 hours and the second predetermined time to 12 hours. However, these times are merely examples, and it goes without saying that they can be set longer or shorter as appropriate.

Furthermore, in the optional embodiment described above, the second authentication code is transmitted to the in-vehicle controller 4 only when at least one set of ignition-off signals and ignition-on signals is received. However, the number of sets of ignition-off signals and ignition-on signals required as the condition for transmitting the second authentication code to the in-vehicle controller 4 may be set to at least n sets (where n is any integer) instead of at least one set. Additionally, an appropriate threshold may be set for the time interval from receiving the ignition-off signal to receiving the ignition-on signal, and if the time interval is equal to or less than the threshold, it may be ignored. This enables the vehicle information management device capable with vehicles equipped with an automatic idle stop function.

Additionally, upon authentication registering the new owner, the management server 2 may restrict the functionality of some or all telematics services related to the vehicle 6 on the mobile device 3-2 owned by the previous owner. This is because it would be problematic that the former owner, who is no longer the owner, could see on his/her mobile device the current location of the vehicle being driven by the new owner if the new owner is the rightful owner of the vehicle 6.

### EXPLANATION OF REFERENCE NUMERALS

1 registration system
2 management server
2a arithmetic unit
211 vehicle/user information management unit
212 control unit
2b storage unit
221 vehicle/user information database
2c wireless communication unit
231 transmission unit
232 reception unit
2d display unit
2e input unit
3 mobile device
3a control unit
311 location information transmission and reception unit
312 route guide unit
3b storage unit
321 pairing information
322 location information
3c wireless communication unit
331 transmission unit
332 reception unit
3d display unit
3e input unit
3f near field communication unit
3g sensor unit
4 in-vehicle controller
4a ECU (Electronic Control Unit)
411 location information transmission unit
412 route guide unit
413 electronic equipment control unit
4b storage unit
421 pairing information
422 location information
4c TCU (Telematics Control Unit)
431 wireless communication circuit
432 near field communication circuit
4g various switches and sensors
4h various electronic devices
5 IVI (In-Vehicle Infotainment) device
5d display unit
5e input unit
6 vehicle
7 wireless communication network
8 near field communication

What is claimed is:

1. A vehicle information management device comprising:
a user information management unit configured to register owner information pertaining to a vehicle including user identification information and contact details for a user;
a reception unit configured to receive an authentication registration request from either a first mobile device held by a first user who becomes a new owner of the vehicle or a vehicle information device mounted in the vehicle;
a transmission unit configured to transmit, to the vehicle information device, first authentication code information to be displayed on the vehicle information device when the authentication registration request is received; and
a control unit configured to:
receive, by the reception unit, first authentication code confirmation information, which is information generated by the first mobile device reading the first authentication code information displayed on the vehicle information device;
transmit from the transmission unit, if it is confirmed that contents of authentication registration information contained respectively in the first authentication code information and in the first authentication code confirmation information match, second authentication code information to be displayed on the vehicle information device within a first predetermined time period from the confirmation;
receive, by the reception unit, second authentication code confirmation information, which is information generated by the first mobile device reading the second authentication code information; and
instructs the user information management unit to register the identification information of the first user as an owner information for the vehicle, if it is confirmed that the contents of authentication registration information contained respectively in the second authentication code information and the second authentication code confirmation information match.

2. The vehicle information management device according to claim 1, wherein
the reception unit further receives “on” information indicating that the vehicle is in a started state and “off” information indicating that the vehicle is in a non-started state, and
the control unit, after confirming that contents of authentication registration information contained respectively in the first authentication code information and the first authentication code confirmation information match, receives the “off” information, subsequently, after receiving the “on” information, and if it confirms that contents of authentication registration information contained respectively in the second authentication code information and the second authentication code confirmation information match, instructs the user information management unit to register the identification information of the first user as an owner information for the vehicle.

3. The vehicle information management device according to claim 1, wherein
the control unit, after confirming that contents of authentication registration information contained respectively in the first authentication code information and the first authentication code confirmation information match, transmits the second authentication code information to the vehicle information device after a second predetermined time shorter than the first predetermined time has elapsed, and if it confirms that the contents of authentication registration information contained respectively in the second authentication code information and the second authentication code confirmation information match, instructs the user information management unit to register the identification information of the first user as an owner information for the vehicle.

4. The vehicle information management device according to claim 1, wherein
the control unit, after transmitting the second authentication code information to be displayed on the vehicle information device from the transmission unit to the vehicle information device, if it receives the second authentication code confirmation information from a second mobile device held by a second user who is the former owner of the vehicle, it instructs the user information management unit not to register the identification information of the first user as an owner information for the vehicle.
